(19) United States
(12) Patent Application Publication
(10) Pub. No.: US 2003/0084166 A1
(43) Pub. Date: May 1, 2003

(54) Server computer, its connection close method and computer program product therefor

(76) Inventor: Nobuhisa Hosoi, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/284,291

(22) Filed: Oct. 31, 2002

(30) Foreign Application Priority Data
Nov. 1, 2001 (JP) 336955/2001

(51) Int. Cl. G06F 15/16

(52) U.S. Cl. 709/227

(57) ABSTRACT

A server computer conducts a method making it possible to close half-open connections in a server object when half-open connection frequently occurs and new connections cannot be formed. In the computer, a communication controller means controls communication between a client and a server object that provides a service to the client, by establishing and releasing a connection between the client and the object. A monitor means monitors a count of the connections between the client and the object. A destruction/generation controller means destroys the object or generating a new server object under the control of the monitor. When the monitor means detects an event that the connection count of the connections between the client and the object reaches a maximum connection number, the monitor instructs the destruction/generation controller means to destroy the object. Immediately after the object is destroyed, the monitor instructs the destruction/generation controller means to generate a new server object.

### BACKGROUND OF THE INVENTION

1. Field of the Invention

The present invention relates to a server computer, its connection close method, and a computer program product for conducting the method, which are preferably used in a distributed object system. More particularly, the invention relates to a server computer having a connection close function, a connection close method for closing connection between a server computer and a client computer or computers, and a computer program product for conducting the method.

2. Description of the Related Art

A distributed object system is a system where a server object makes communication with a client by establishing a connection (i.e., a logical communication path) between the object and the client. This is to transmit data between the object and the client. With the system of this type, if a floating connection is repeatedly caused in the server object by a so-called “half-open connection and the count of the connections reaches a specific maximum connection number, there arises a problem that a new connection is unable to be established between the object and the client.

The term “half-open connection” means an in-process connection where synchronization is not made between the corresponding ends of two connections, which is caused by the event that one of the two connections is closed or aborted without regarding the state of the other, or that one of the two connections is destroyed or broken due to the shortage of memories. A half-open connection is automatically reset if data is transmitted by way of it in one of its two directions.

With a distributed object system, as described above, when a connection is aborted on a client side and the closing operation of the said connection is not synchronized with the aborting operation on a server object side, a half-connection will occur on the server object side. In this case, a half-open connection will remain as a floating connection. This is because data transmission is not tried from the server object in the system of this type and thus, a half-open connection will not automatically reset. If the count of the floating connections thus formed reaches a specific maximum connection number, a problem that new connections are unable to be established at the server object side arises.

To solve the said problem, an improved server object has been developed, where connection close means is provided for closing the connections when no data transmission is conducted within a specific monitoring period. In this case, half-open connections can be closed. However, there is another problem that new are unable to be established at a server object until the monitoring period expires and the half-open connections (i.e., floating connections) are closed, if the count of floating connections reaches the specific maximum connection number within the specific monitoring period. This problem can be solved by reducing the monitoring period. If so, however, there arises an anxiety that normal connections are closed.

### SUMMARY OF THE INVENTION

Accordingly, an object of the present invention is to provide a server computer, its connection close method, and a computer program product for conducting the method that make it possible to close half-open connections at a server object when half-open connection frequently occurs and new connections are unable to be formed.

Another object of the present invention is to provide a server computer, its connection close method, and a computer program product for conducting the method that eliminate the anxiety that normal connections are closed when no half-open connections are generated.

Still another object of the present invention is to provide a server computer, its connection close method, and a computer program product for conducting the method that make it possible to establish a new connection immediately after the count of floating connections reaches a maximum connection number to thereby destroy a server object.

The above objects together with others not specifically mentioned will become clear to those skilled in the art from the following description.

According to a first aspect of the present invention, a server computer is provided. This server computer comprises:

communication controller means for controlling communication between a client and a server object that provides a service to the client, by establishing and releasing a connection between the client and the object;

monitor means for monitoring a count of connections of the server object; and

generation/destruction controller means for destroying the server object and for generating a new server object under the control of the monitor means;

wherein when the monitor means detects an event that the count of the connections of the server object reaches a maximum connection number, the monitor means instructs the generation/destruction controller means to break or destroy the object;

and wherein immediately after the object is broken or destroyed, the monitor means instructs the generation/destruction controller means to generate a new server object.

With the server computer according to the first aspect of the present invention, the monitor means is provided outside the server object. Moreover, if the monitor means detects or find an event that the count of the connections of the server object reaches the specific maximum connection number during the communication between the server object and the client, the monitor means determines that many floating connections are caused by half-open connections. Thereafter, the monitor means instructs the generation/destruction controller means to destroy the object. Therefore, closing of the half-open connections is realized and ensured.

Furthermore, since the connections between the server object and the client are closed only when the count of the connections of the server object reaches the specific maximum connection number, the disadvantage or anxiety that normal connections are closed in spite of no half-open connections being generated is prevented.

A new server object is generated by the generation/destruction controller means immediately after the server object where the count of the connections has been maximized in destroyed. Therefore, a new connection or connections is/are established promptly between the server object and the client.

According to a second aspect of the present invention, another server computer is provided. This server computer comprises:

communication controller means for controlling communication between a client and a server object that provides a service to the client, by establishing and releasing a connection between the client and the object;

the communication controller means detecting a count of connections of the server object;

the communication controller means notifying an event that the count of the connections of the server object reaches a specific maximum connection number;

generation/destruction controller means for destroying the server object and generating a new server object; and

monitor means for monitoring a count of connections of the server object;

wherein when the monitoring means recognizes, from notification from the communication controller means, the event that the count of the connections of the server object reaches the maximum connection number, the monitor means instructs the generation/destruction controller means to destroy the server object;

and wherein the monitor means instructs the generation/destruction controller means to generate a new server object immediately after the server object is destroyed.

With the server computer according to the second aspect of the present invention, the monitor means is provided outside the server object and at the same time, the communication controller means is provided to detect the count of the connections of the server object. The communication controller means notifies the event that the count of the connections of the server object reaches the specific maximum connection number to the monitor means. In response to this notification, the monitor means determines that many floating connections are caused by half-open connections. Thereafter, the monitor means instructs the generation/destruction controller means to destroy the server object. Therefore, closing of the half-open connections is realized and ensured.

Furthermore, since the connections are closed only when the count of the connections of the server object reaches the specific maximum connection number, the disadvantage or anxiety that normal connections are closed in spite of no half-open connections being generated is prevented.

A new server object is generated by the generation/destruction controller means immediately after the server object where the count of connections has been maximized is destroyed. Therefore, a new connection or connections is/are established promptly.

According to a third aspect of the invention, a method of closing connection of a server object with a client is provided, said method comprising the steps of:

monitoring by monitoring means a count of connections of a server object, the server object supplying services to a client;

instructing generation/destruction controller means to destroy the server object if the count of connections of the server object reaches a maximum connection number, thereby closing all the connections of the server object with the client; and

instructing the generation/destruction controller means to generate a new server object immediately after destroying the server object.

With the method of closing connection in a server computer between a server object and a client according to the third aspect, there are the same advantages are obtainable because of substantially the same reason as shown in the server computer according to the first aspect of the invention. This is because the method of the third aspect corresponds to the server computer of the first aspect.

According to a fourth aspect of the invention, another method of closing connection of a server object with a client is provided, said method comprising the steps of:

monitoring by a communication controller means a count of connections of a server object, the server object supplying services to the client;

notifying an event that the count of connections of the server object reaches a maximum connection number to the monitor means by the communication controller means;

instructing generation/destruction controller means to destroy the server object when the count of connections of the server object reaches the maximum connection number is notified, thereby closing all the connections of the server object with the client; and

instructing the generation/destruction controller means to generate a new server object immediately after destroying the server object.

With the method of closing connection in a server computer between a server object and a client according to the fourth aspect, there are the same advantages as those of the server computer according to the second aspect are obtainable because of substantially the same reason as shown in the server computer according to the second aspect of the invention. This is because the method of the fourth aspect corresponds to the server computer of the second aspect.

According to a fifth aspect of the invention, a computer program product for closing connection of a server object with a client is provided. This product is to conduct the method according to the third aspect of the invention. This product has a computer readable medium and a computer program recorded thereon, which comprises:

code that monitors by monitoring means a count of connections of a server object, the server object supplying services to the client;

code that instructs generation/destruction controller means to destroy the server object if the count of connections of the server object reaches a maximum connection number, thereby closing all the connections of the server object with the client; and

code that instructs the generation/destruction controller means to generate a new server object immediately after destroying the server object.

With the computer program product according to the fifth aspect of the invention, obviously, there are the same advantages as those of the method according to the third aspect of the invention.

According to a sixth aspect of the invention, another computer program product for closing connection of a server object with a client is provided. This product is to conduct the method according to the fourth aspect of the invention. This product has a computer readable medium and a computer program recorded thereon, which comprises:

code that monitors by a communication controller means a count of connections of a server object, the server object supplying services to the client;

code that notifies an event that the count of connections of the server object reaches a maximum connection number to the monitor means by the communication controller means;

code that instructs generation/destruction controller means to destroy the server object when the count of connections of the server object reaches the maximum connection number is notified, thereby closing all the connections of the server object with the client; and

code that instructs the generation/destruction controller means to generate a new server object immediately after destroying the server object.

With the computer program product according to the sixth aspect of the invention, obviously, there are the same advantages as those of the method according to the fourth aspect of the invention.

### BRIEF DESCRIPTION OF THE DRAWINGS

In order that the present invention may be readily carried into effect, it will now be described with reference to the accompanying drawings.

FIG. 1 is a functional block diagram showing the configuration of a distributed object system including a server computer according to a first embodiment of the present invention

FIG. 2 is a sequence diagram showing the operation sequence of the server computer according to the first embodiment in the distributed object system of FIG. 1.

FIG. 3 is a functional block diagram showing the configuration of a distributed object system including a server computer according to a second embodiment of the present invention.

FIG. 4 is a sequence diagram showing the operation sequence of the server computer according to the second embodiment in the distributed object system of FIG. 3.

FIG. 5 is a functional block diagram showing the configuration of a distributed object system including a server computer according to a third embodiment of the present invention.

FIG. 6 is a sequence diagram showing the operation sequence of the server computer according to the third embodiment in the distributed object system of FIG. 5, where the first server object is associated.

FIG. 7 is a sequence diagram showing the operation sequence of the server computer according to the third embodiment in the distributed object system of FIG. 5, where the second server object is associated.

### DETAILED DESCRIPTION OF THE PREFERRED EMBODIMETNS

Preferred embodiments of the present invention will be described in detail below while referring to the drawings attached.

### First Embodiment

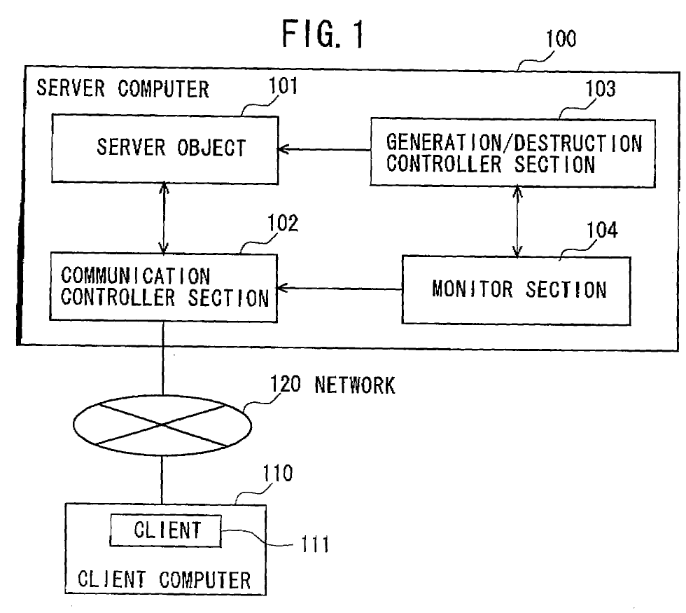

A distributed object system including a server computer 100 according to a first embodiment of the invention is schematically shown in FIG. 1. This system further comprises a client computer 110 connected to the server computer 100 by way of a network 120. These two computers 100 and 110 are communicable with each other through the network 120.

The server computer 100 according to the first embodiment comprises a server object 101, a communication controller section 102, a generation/destruction controller section 103, and a monitor section 104. The client computer 110 comprises a client 111.

The server object 101 supplies specific services to the client 111 with the communication function of the communication controller section 102. Thus, data transmission between the server object 101 and the client 111 can be realized.

The communication controller section 102 controls the communication operation between the server object 101 and the client 111, thereby establishing connections between the server object 101 and the client 111 for conducting data transmission/reception, and closing the connections. Moreover, the section 102 manages the number or count (i.e., total number) of the connections generated at the server object 101.

The generation/destruction controller section 103 is used to destroy the current server object 101 and generate a new server object according to the necessity.

The monitor section 104 monitors the number or count of the connections at the server object 101 periodically using the communication controller section 102. This is to detect an event that the count of the connections generated at the object 101 has reached a specific maximum connection number. When the event that the count of the connections generated at the object 101 reaches the specific maximum connection number occurs, the communication controller section 102 notifies it to the monitor section 104. In response to this notification from the section 102, the section 104 instructs the generation/destruction controller section 103 to destroy the current object 101 and then, to generate a new server object instead.

In the server computer 100, as seen from the above explanation, if an event that the count of the connections at the server object 101 has reached the specific maximum connection number is detected or found during the communication operation between the server object 101 and the client 111, the monitor section 104 determines that many floating connections have been caused by half-open connections. Thereafter, the monitor section 104 instructs the generation/destruction controller section 103 to destroy the current server object 101. When the object 101 is destroyed all the connections generated between the object 101 and the client 111 are closed. Thereafter the monitor section 104 instructs the generation/destruction controller section 103 to generate a new server object for recovery, thereby making it possible to establish new connections between the new server object thus generated and the client 111.

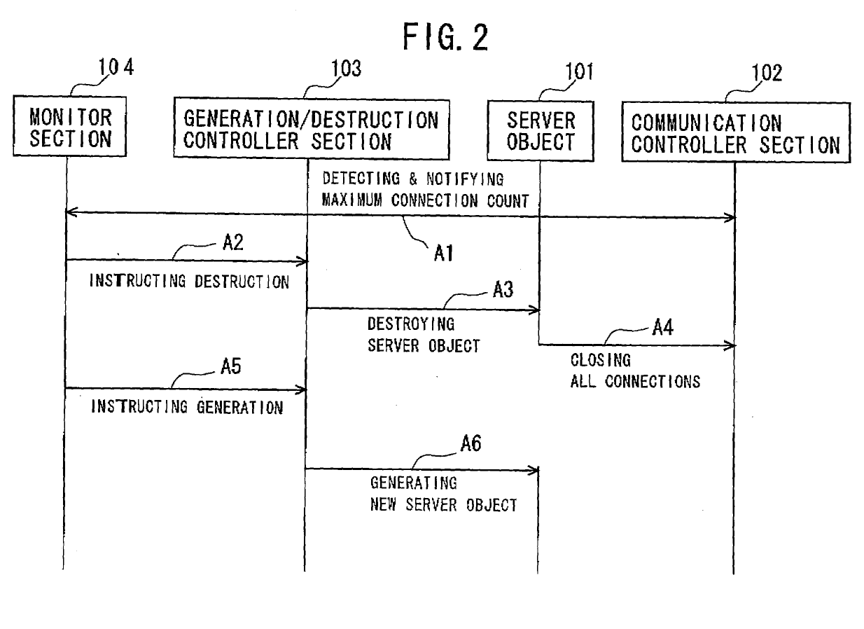

Next, the operation sequence of the server computer 100 according to the first embodiment of FIG. 1 will be explained below with reference to FIG. 2.

In the operation of the server computer 100, the connection close method of the computer 100 according to the first embodiment is executed. This method is provided by a computer program recorded on a computer readable medium. This is applicable to the following second and third embodiments.

The monitor section 104 periodically monitors the number or count of connections generated at the server object 101 by way of the communication controller section 102. If the communication controller section 102 detects or recognizes the occurrence of an event that the count (i.e., total number) of connections formed at the object 101 reaches the specific maximum connection number, the section 102 notifies the detection or recognition of the event to the monitor section 104 (step A1).

In response to this notification from the communication controller section 102, the monitor section 104 makes a decision that many (e.g., unallowable) floating connections have been caused by half-open connections. Thereafter, the monitor section 104 instructs the generation/destruction controller section 103 to destroy the current server object 101 (step A2). The “maximum connection number” is the maximum number of connections that can be made at the server object 101.

In response to the instruction from the monitor section 104, the generation/destruction controller section 103 instructs the server object 101 to be destroyed (step A3). In response to this instruction, the object 101 instructs the communication controller section 102 to close all the connections that have been formed (step A4) between the object 101 and the client 111. Thereafter, the object 101 is destroyed according to the instruction that has been sent from the generation/destruction controller section 103.

Subsequently, to make it possible to newly establish connections between a new server object and the client 111, the monitor section 104 instructs the generation/destruction controller section 103 to generate a new server object for recovery (step A5). In response to this instruction from the section 104, the section 103 generates a new server object instead of the server object 101 (step A6). The generation of a new server object is conducted immediately after the destruction of the current server object 101. Thereafter, the communication controller section 102 establishes a new connection or connections between the new server object thus generated and the client 111 according to the necessity.

With the server computer 100 according to the first embodiment of FIG 1, as explained above, the monitor section 104 is provided outside the server object 101. Moreover, if the monitor section 104 detects or find the occurrence that an event that the count of the connections generated at the server object 101 has reached the specific maximum connection number by way of the communication controller section 102 during the communication between the server object 101 and the client 111, the monitor section 104 determines that many floating connections have been caused at the server object 101 due to half-open connections. Thereafter, the monitor section 104 instructs the generation/destruction controller section 103 to destroy the current server object 101. Therefore, closing of the half-open connections is realized and ensured.

Furthermore, since the existing connections are closed only when the count of the connections generated at the server object 101 has reached the specific maximum connection number, the disadvantage or anxiety that normal connections are closed in spite of no or a small number of half-open connections being generated is prevented.

A new server object is generated immediately after the server object 101 where the count of connections has been maximized is destroyed and therefore, a new connection or connections is/are established promptly.

### Second Embodiment

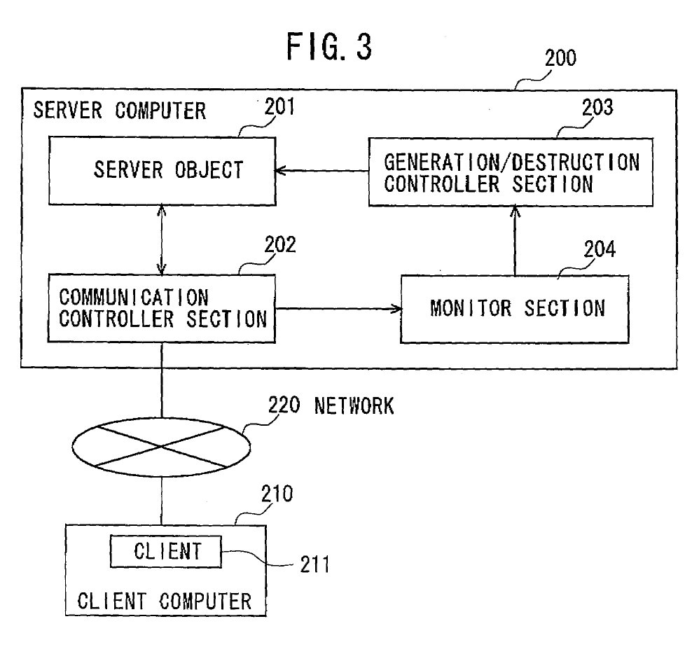

FIG. 3 schematically shows a distributed object system including a server computer 200 according to a second embodiment of the invention. This system further comprises a client computer 210 connected to the server computer 200 by way of a network 220. These two computers 200 and 210 are communicable with each other through the network 220.

The server computer 200 comprises a server object 201, a communication controller section 202, a generation/destruction controller section 203, and a monitor section 204. The client computer 210 comprises a client 211.

The server object 201 supplies specific services to the client 211 with the communication function of the communication controller section 202. Thus, data transmission between the server object 201 and the client 211 can be realized.

In the server computer 200 according to the second embodiment, the operations of the communication controller section 202 and the monitor section 204 are different from those of the server computer 100 according to the first embodiment.

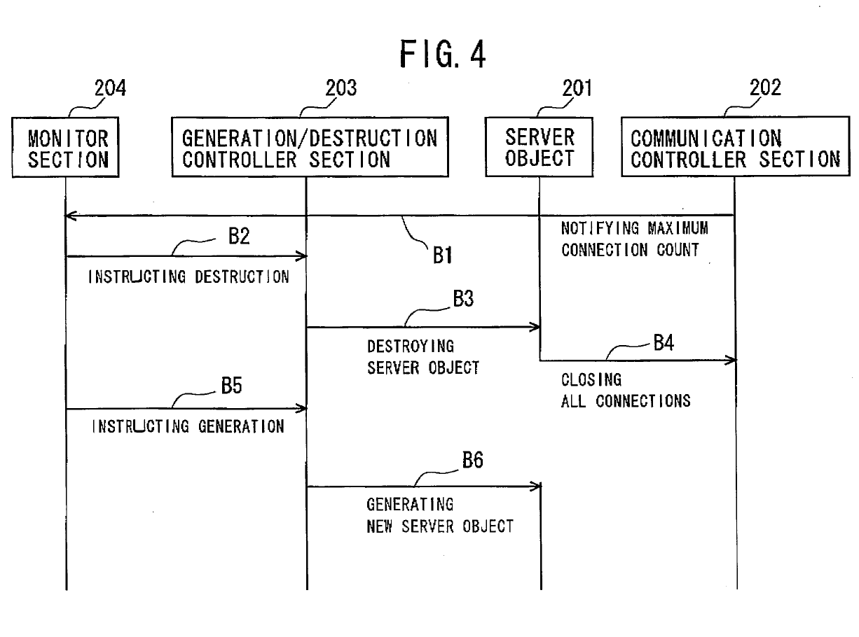

Specifically, in the server computer 200, as shown in FIG. 4 that describes the operation sequence of the computer 200, the communication controller section 202 manages the number of connections generated at the server object 201. If an event that the number of connections reaches a specific maximum connection number of the object 201 occurs, the section 202 notifies the occurrence of the event to the monitor section 204 (step B1).

By the notification from the communication controller section 202, the monitor section 204 detects or recognizes the event that the count (i.e., total number) of connections formed at the object 201 has reached the specific maximum connection number. In response to this notification, the monitor section 204 makes a decision that many (e.g., unallowable) floating connections have been caused by half-open connections at the current server object 201. Thereafter, the monitor section 204 instructs the generation/destruction controller section 203 to destroy the current server object 201 (step B2).

In response to the instruction from the monitor section 204, the generation/destruction controller section 203 instructs the server object 201 to be destroyed (step B3). In response to this instruction, the object 201 instructs the communication controller section 202 to close all the connections that have been formed (step B4) between the object 201 and the client 211. Thereafter, the object 201 is destroyed according to the instruction from the generation/destruction controller section 203.

Subsequently, to make it possible to newly establish connections between a new server object and the client 211, the monitor section 204 instructs the generation/destruction controller section 203 to generate a new server object for recovery (step B5). In response to this instruction from the section 204, the section 203 generates a new server object instead of the server object 201 (step 26). The generation of a new server object is conducted immediately after the destruction of the current server object 201. Thereafter, the communication controller section 202 establishes a new connection or connections between the new server object thus generated and the client 211 according to the necessity.

With the server computer 200 according to the second embodiment of FIG. 3, as explained above, the monitor section 204 is provided outside the server object 201. Moreover, by the notification from the communication controller section 202, the monitor section 204 recognizes the occurrence of an event that the count of the connections generated at the server object 201 has reached the specific maximum connection number during the communication between the server object 201 and the client 211. At this time, the monitor section 204 determines that many floating connections have been caused at the server object 201 due to half-open connections. Thereafter, the monitor section 204 instructs the generation/destruction controller section 203 to destroy the object 201. Therefore, closing of the half-open connections is realized and ensured.

Furthermore, since the existing connections are closed only when the count of the connections generated at the server object 201 reaches the specific maximum connection number, the disadvantage or anxiety that normal connections are closed in spite of no or small number of half-open connections being generated is prevented.

A new server object is generated immediately after the server object 201 where the count of connections has been maximized is destroyed and therefore, a new connection or connections is/are established promptly.

### Third Embodiment

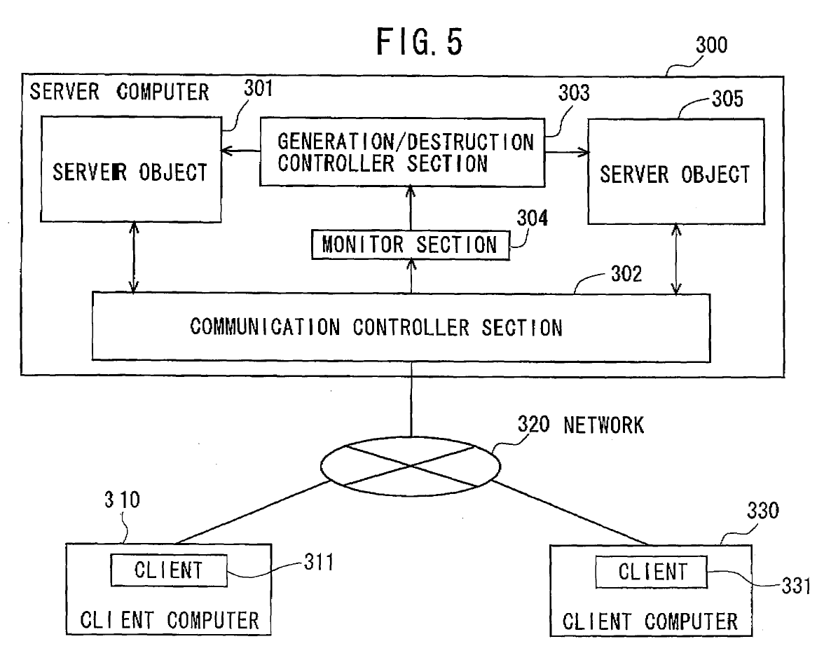

FIG. 5 schematically shows a distributed object system including a server computer 300 according to a third embodiment of the invention. Unlike the above-described first and second embodiments, this system further comprises two client computers, a first client computer 310 and a second client computer 330, both of which are connected to the server computer 300 by way of a network 320. These computers 300, 310, and 330 are communicable with each other through the network 320. The first client computer 310 comprises a first client 311. The second client computer 330 comprises a second client 331.

Moreover, unlike the above-described first and second embodiments, the sever computer 300 according to the third embodiment comprises a first server object 301 and a second server object 305, along with a communication controller section 302, a generation/destruction controller section 303, and a monitor section 304.

The first server object 301 supplies specific services to the first client 311 and/or the second client 331 with the communication function of the communication controller section 302. The first object 301 is communicable with the first client 311 and/or the second client 331 by way of a connection or connections established therebetween. Similarly, the second server object 305 supplies specific services to the first client 311 and/or the second client 331 with the communication function of the communication controller section 302. The second object 305 is communicable with the first client 311 and/or the second client 331 by way of a connection or connections established therebetween.

The communication controller section 302 controls the communication operation between the first and second server objects 301 and 305 and the first and second clients 311 and 331, thereby establishing connections between the server objects 301 and 305 and the clients 311 and 331 for establishing connections, conducting data transmission/reception, and closing the connections. Moreover, the section 302 manages the counts of the connections generated at the first and second server objects 301 and 305.

The generation/destruction controller section 303 is used to destroy the first and/or second server object or objects 301 and/or 305 and to generate a new server object or objects instead.

The monitor section 304 monitors the numbers or counts of the connections at the first and second server objects 301 and 305 periodically using the communication controller section 302. This is to detect an event that the count of the connections generated at the first and/or second server objects 301 and/or 305 has reached a specific maximum connection number. When the count of the connections generated at the first or second object 301 or 305 reaches the specific maximum connection number, the communication controller section 302 notifies it to the monitor section 304. In response to this notification from the section 302, the section 304 instructs the generation/destruction controller section 303 to destroy the current first or second object 301 or 305 and to generate a new server object or objects instead.

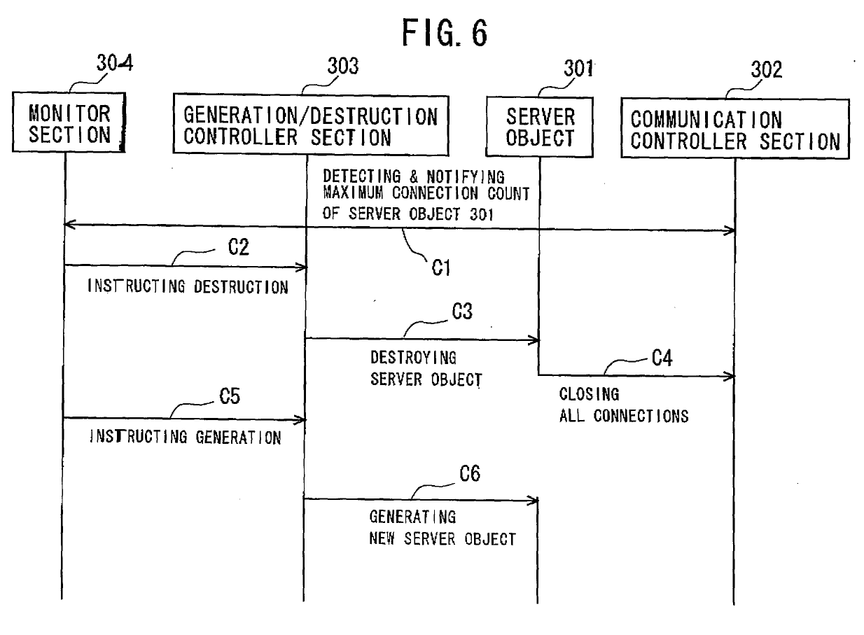

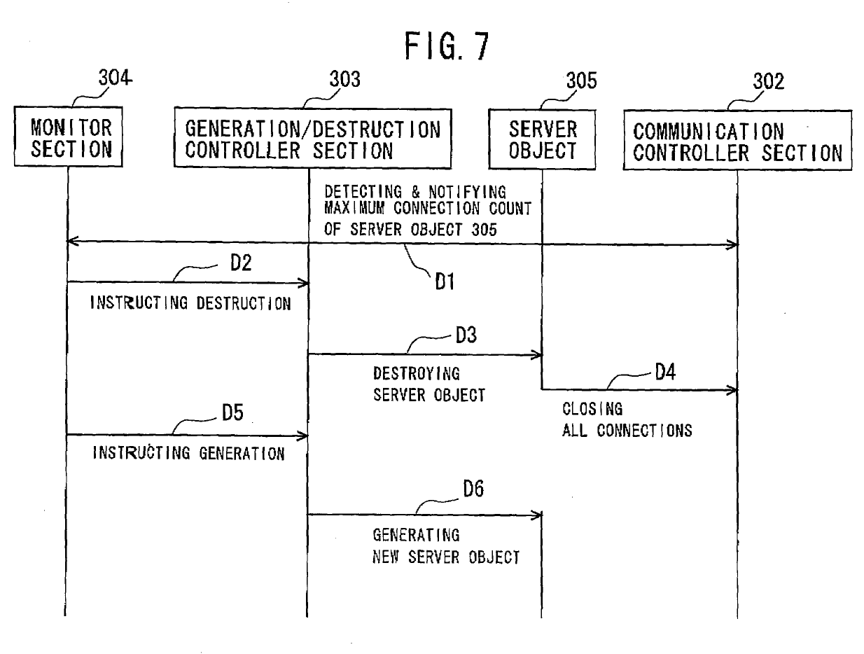

Next, the operation sequence of the server computer 300 according to the third embodiment will be explained below with reference to FIGS. 6 and 7.

The monitor section 304 periodically monitors the number or count of connections at the first and second server objects 301 and 305 by way of the communication controller section 302. If the section 304 detects or recognizes an event that the count of connections formed at the first object 301 has reached the specific maximum connection number by way of the section 302, the section 304 conducts the operation sequence shown in FIG. 6.

Specifically, if the communication controller section 302 detects or recognizes an event that the count of connections formed at the first object 301 has reached the specific maximum connection number by way of the section 302, the section 302 notifies the detection or recognition of the event to the monitor section 304 (step C1).

In response to this notification from the communication controller section 302, the monitor section 304 makes a decision that many floating connections have been caused by half-open connections. Thereafter, the monitor section 304 instructs the generation/destruction controller section 303 to destroy the current first server object 301 (step C2).

In response to the instruction from the monitor section 304, the generation/destruction controller section 303 instructs the first server object 301 to be destroyed (step C3). In response to this instruction, the first object 301 instructs the communication controller section 302 to close all the connections that have been formed between the first object 301 and the first or second client 311 or 331 (step C4). Thereafter, the first object 301 is destroyed according to the instruction from the generation/destruction controller section 303.

Subsequently, to make it possible to newly establish connections between a new first server object and the first or second client 311 or 331, the monitor section 304 instructs the generation/destruction controller section 303 to generate a new first server object (step C5). In response to this instruction from the section 304, the section 303 generates a new first server object instead of the first server object 301 (step C6). The generation of a first new server object is conducted immediately after the destruction of the current first server object 301. Thereafter, the communication controller section 302 establishes a new connection or connections between the new first server object thus generated and the first or second client 311 or 331.

On the other hand, if the monitor section 304 detects or recognizes an event that the count of connections formed at the second object 305 has reached a specific maximum connection number by way of the section 302, the section 304 conducts the operation sequence shown in FIG. 7.

Specifically, if the communication controller section 302 detects or recognizes an event that the count of connections formed at the second object 305 has reached a specific maximum connection number by way of the section 302, the section 302 notifies the detection or recognition of the event to the monitor section 304 (step D1).

In response to this notification from the communication controller section 302, the monitor section 304 makes a decision that many floating connections have been caused by half-open connections. Thereafter, the monitor section 304 instructs the generation/destruction controller section 303 to destroy the current second server object 305 (step D2).

In response to the instruction from the monitor section 304, the generation/destruction controller section 303 instructs the second server object 305 to be destroyed (step D3). In response to this instruction, the second object 305 instructs the communication controller section 302 to close all the connections that have been formed between the second object 305 and the first or second client 311 or 331 (step D4). Thereafter, the second object 305 is destroyed according to the instruction from the generation/destruction controller section 303.

Subsequently, to make it possible to newly establish connections between a new second server object and the first or second client 311 or 331, the monitor section 304 instructs the generation/destruction controller section 303 to generate a new second server object (step D5). In response to this instruction from the section 304, the section 303 generates a new second server object instead of the second server object 305 (step D6) The generation of a second new server object is conducted immediately after the destruction of the current second server object 305. Thereafter, the communication controller section 302 establishes a new connection or connections between the new second server object thus generated and the first or second client 311 or 331.

With the server computer 300 according to the third embodiment of FIG. 5, as explained above, the monitor section 304 is provided outside the first and second server objects 301 and 305. Moreover, it the monitor section 304 detects or find an event that the count of the connections generated at the first or second server object 301 or 305 has reached the specific maximum connection number during the communication between the first or second server object 301 or 305 and the first or second client 311 or 331 by way of the communication controller section 302, the monitor section 304 determines that many floating connections are caused by half-open connections. Thereafter, the monitor section 304 instructs the generation/destruction controller section 303 to destroy the current first and/or second server object(s) 301 and/or 305. Therefore, closing of the half-open connections is realized and ensured.

Furthermore, since the existing connections are closed only when the count of the connections generated at the first or second server object 301 or 305 has reached the corresponding maximum connection number, the disadvantage or anxiety that normal connections are closed in spite of no or a small number of half-open connections being generated is prevented.

A new server object is generated immediately after the first and/or second server object or objects 301 and/or 305 where the count of connections has been maximized is/are destroyed and therefore, a new connection or connections is/are established promptly.

### Variations

Needless to say, the present invention is not limited to the above-described first to third embodiments, because they are preferred examples of the invention. Any change or modification maybe added to them within the spirit of the invention. For example, one or two server objects and one of two clients are provided in the server computer according to the first to third embodiments. However, needless to say, the number of server objects and the number of clients are optionally changeable.

Moreover, the invention is applicable to any one of the connection-type communications systems where a connection (i.e., a logical communication path) is established between entities prior to data transmission.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A server computer comprising:
communication controller means for controlling communication between a client and a server object that provides a service to the client, by establishing and releasing a connection between the client and the object;
monitor means for monitoring a count of connections of the server object; and
generation/destruction controller means for destroying the server object and for generating a new server object under the control of the monitor means;
wherein when the monitor means detects an event that the count of the connections of the server object reaches a maximum connection number, the monitor means instructs the generation/destruction controller means to break or destroy the object;
and wherein immediately after the object is broken or destroyed, the monitor means instructs the generation/destruction controller means to generate a new server object.

2. The computer according to claim 1, wherein
the monitor means monitors the count of connections of the server object by way of the communication controller means.

3. A server computer comprising:
communication controller means for controlling communication between a client and a server object that provides a service to the client, by establishing and releasing a connection between the client and the object;
the communication controller means detecting a count of connections of the server object;
the communication controller means notifying an event that the count of the connections of the server object reaches a specific maximum connection number;
generation/destruction controller means for destroying the server object and generating a new server object; and
monitor means for monitoring a count of connections of the server object;
wherein when the monitoring means recognizes, from notification from the communication controller means, the event that the count of the connections of the server object reaches the maximum connection number, the monitor means instructs the generation/destruction controller means to destroy the server object;
and wherein the monitor means instructs the generation/destruction controller means to generate a new server object immediately after the server object is destroyed.

4. A method of closing connection of a server object with a client, said method comprising the steps of:
monitoring by monitoring means a count of connections of a server object, the server object supplying services to a client;
instructing generation/destruction controller means to destroy the server object if the count of connections of the server object reaches a maximum connection number, thereby closing all the connections of the server object with the client; and
instructing the generation/destruction controller means to generate a new server object immediately after destroying the server object.

5. The method according to claim 4, wherein
the monitor means monitors the count of connections of the server object by way of communication controller means.

6. A method of closing connection of a server object with a client, said method comprising the steps of:
monitoring by a communication controller means a count of connections of a server object, the server object supplying services to the client;
notifying an event that the count of connections of the server object reaches a maximum connection number to the monitor means by the communication controller means;
instructing generation/destruction controller means to destroy the server object when the count of connections of the server object reaches the maximum connection number is notified, thereby closing all the connections of the server object with the client; and
instructing the generation/destruction controller means to generate a new server object immediately after destroying the server object.

7. A computer program product for closing connection of a server object with a client, the product having a computer readable medium and a computer program recorded thereon, the product comprising:
code that monitors by monitoring means a count of connections of a server object, the server object supplying services to the client;
code that instructs generation/destruction controller means to destroy the server object if the count of connections of the server object reaches a maximum connection number, thereby closing all the connections of the server object with the client; and
code that instructs the generation/destruction controller means to generate a new server object immediately after destroying the server object.

8. The product according to claim 7, wherein
the monitor means monitors the count of connections of the server object by way of communication controller means.

9. A computer program product for closing connection of a server object with a client, the product having a computer readable medium and a computer program recorded thereon, the product comprising:
code that monitors by a communication controller means a count of connections of a server object, the server object supplying services to the client;
code that notifies an event that the count of connections of the server object reaches a maximum connection number to the monitor means by the communication controller means;
code that instructs generation/destruction controller means to destroy the server object when the count of connections of the server object reaches the maximum connection number is notified, thereby closing all the connections of the server object with the client; and
code that instructs the generation/destruction controller means to generate a new server object immediately after destroying the server object.
